(19) United States
(12) Patent Application Publication
(10) Pub. No.: US 2023/0099860 A1
(43) Pub. Date: Mar. 30, 2023

(54) UNIFORM LIGHT HALO FOR SINGLE KEYBOARD KEY

(71) Applicant: Apple Inc., Cupertino, CA (US)

(72) Inventors: Pierre P. SOULOUMIAC, Sunnyvale, CA (US); Kevin M. ROBINSON, Sunnyvale, CA (US); William P. YARAK, III, San Francisco, CA (US); Gregory D. CARINI, Cupertino, CA (US); Pengyuan HUANG, San Jose, CA (US)

(21) Appl. No.: 17/952,021

(22) Filed: Sep. 23, 2022

Related U.S. Application Data
(60) Provisional application No. 63/248,359, filed on Sep. 24, 2021.

(51) Int. Cl. F21V 8/00

(52) U.S. Cl. CPC G02B 6/0045; G02B 6/0055; G02B 6/006; G02B 6/0073

(57) ABSTRACT

A keyboard includes a mechanical structure and a key attached to the mechanical structure. A light emitting diode configured to emit light into a light guide panel. A reflector may be attached to the light guide panel and be configured to reflect light from the light guide panel through an opening in the mechanical structure to illuminate a periphery of the key.

### CROSS-REFERENCE TO RELATED APPLICATIONS

This application claims the benefit of priority under 35 U.S.C. § 119 from U.S. Provisional Patent Application 63/248,359, filed Sep. 24, 2021, which is incorporated herein by reference in its entirety.

### TECHNICAL FIELD

The present description relates generally to keyboards including, for example, the back-illumination of keys on a keyboard.

### BACKGROUND

Generally, back-illuminated keyboards try to generate uniform illumination of the glyphs (e.g., letter symbols) in the center of the key while minimizing any halo around the edge of the key, which is considered bleed out or loss. Functional keys, such as fingerprint identification keys, may not have a glyph in the center of the key. For these types of keys, a halo around the edge of the key may be desirable but requires a unique illumination architecture.

### BRIEF DESCRIPTION OF THE DRAWINGS

Certain features of the subject technology are set forth in the appended claims. However, for the purpose of explanation, several embodiments of the subject technology are set forth in the following figures.

FIG. 1 is a diagram illustrating an architecture of an example of a back-illuminated key and a corresponding exploded view according to one or more implementations of the subject technology.

FIGS. 2A and 2B are diagrams illustrating a cut-out view and a corresponding cross-sectional view of a back-illuminated key architecture according to one or more implementations of the subject technology.

FIGS. 3A, 3B, and 3C are diagrams illustrating a perspective view, a bottom view, and a cross-sectional view of a back-illuminated key architecture according to one or more implementations of the subject technology.

FIG. 4 is a diagram illustrating an exploded view of a back-illuminated key architecture according to one or more implementations of the subject technology.

FIG. 5 is a diagram illustrating a cross-sectional view of a back-illuminated key architecture according to one or more implementations of the subject technology.

FIGS. 6A and 6B are diagrams illustrating cross-sectional views of a back-illuminated key architecture according to one or more implementations of the subject technology.

FIG. 7 is a diagram illustrating a cross-sectional view of a back-illuminated key architecture according to one or more implementations of the subject technology.

FIGS. 8A and 8B are diagrams illustrating a top view and a perspective view of a light guide panel according to one or more implementations of the subject technology.

FIG. 9 is a diagram illustrating an exploded view of a back-illuminated key architecture according to one or more implementations of the subject technology.

FIGS. 10A and 10B are diagrams illustrating cross-sectional and perspective views of a back-illuminated key architecture according to one or more implementations of the subject technology.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

As fingerprint identification keys get more integrated into the design of keyboards and have to blend in, back-lighting of such a dedicated key requires the development of custom illumination architecture. Such an architecture should provide a uniform illumination, such as a halo around the key, and may be individually addressable to enable user interactions such as blinking or visual chimes.

According to aspects of the subject technology, a light may be generated under the mechanical structure to which the key is attached (e.g., the top case) and may be slightly offset. One or several light-emitting diodes (LEDs) may be attached to a flexible printed circuit and generate light. The light may be guided by a light guide panel (LGP) which may be microperforated in select locations to make the light shine towards the key in a uniform way. The light may be contained in the LGP by a reflector sheet to improve efficiency and uniformity. The light may shine through micro-perforations or other openings in the mounting element (e.g., top case). The micro-perforations or other openings may be dimensioned with field of view overlap to prevent bright spots.

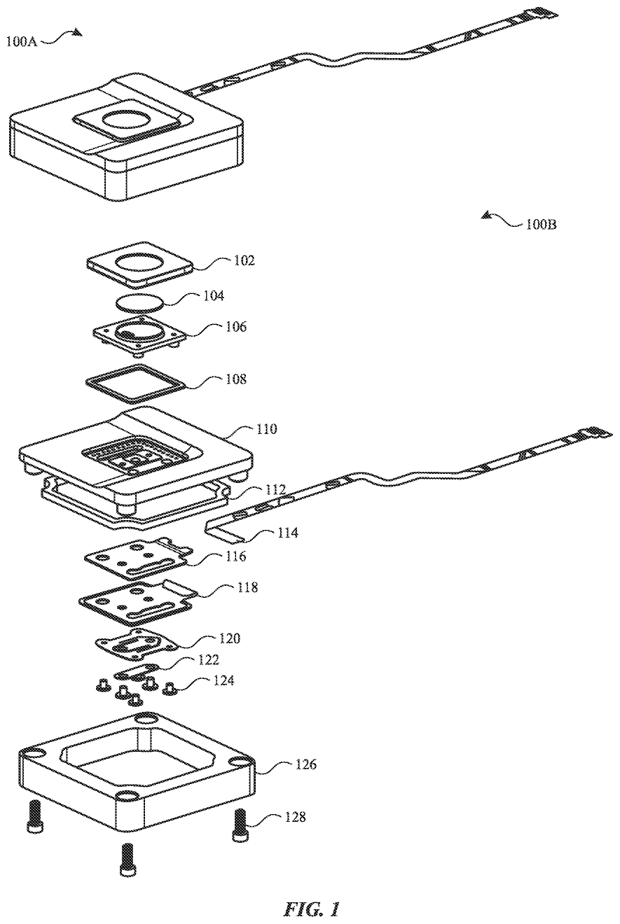

FIG. 1 is a diagram illustrating an architecture of an example of a back-illuminated key 100A and a corresponding exploded view 100B according to one or more implementations of the subject technology. The example back-illuminated key 100A is provided with a uniform halo by using the components shown in the exploded view 100B. The example back-illuminated key 100A may be used with any apparatus including, but not limited to, a desktop, a laptop, a tablet, a phone, or any other electronic or communication device. The exploded view 100B depicts detailed structural components of the back-illuminated key 100A. As depicted in the exploded view 100B, the back-illuminated key 100A includes a key cap 102, a glass 104, a unified trim ring and flex stiffener 106, a light diffusing component 108 (e.g., foam), a top case 110, a light seal 112 (e.g., made of foam and/or other structural materials), an LED 114 (e.g., on a Flex ribbon), an LGP 116, a reflector 118, a flexure 120, an insulator 122, a first set of screws 124 (e.g., M1.2 screws), an enclosure 126, and a second set of screws 128 (e.g., M1.2 screws). In some implementations, the glass 104, and the unified trim ring and flex stiffener 106 may be combined.

In the illustrated example back-illuminated key 100A, light travels from the LED 114 through an illumination stack, including the LGP 116 and the reflector 118, to the edges of the key. The application of a white mask on the top case 110 may help scatter light and provide better uniformity. The LGP 116 converts the linear light from the LED into a surface light source and is made of a transparent material (e.g., an acrylic). The surface of the LGP 116 may be etched in an area under a perforation pattern to scatter light in the perforation. Additional scattering may be obtained by placing a semitransparent material (e.g., a white or semi-transparent foam) on top of the perforation pattern.

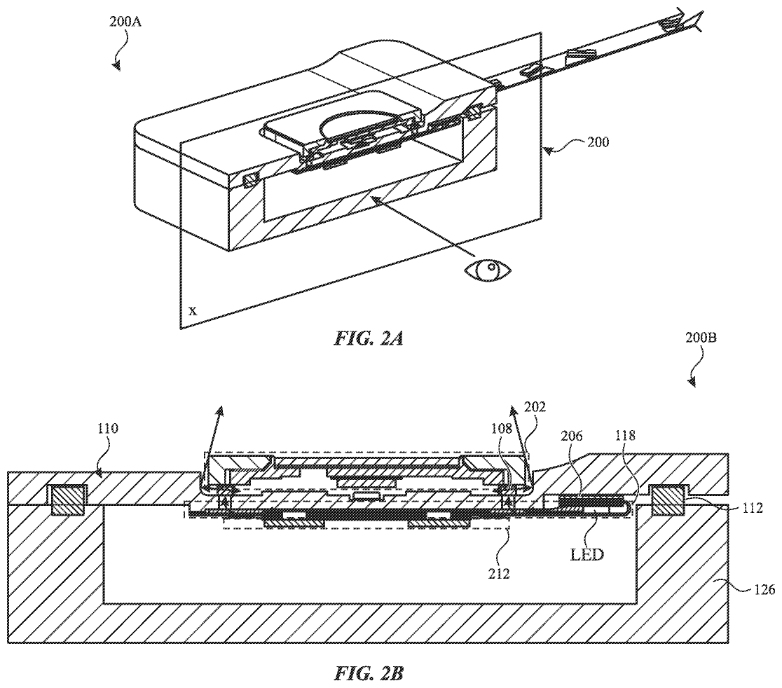

FIGS. 2A and 2B are diagrams illustrating a cut-out view 200A and a corresponding cross-sectional view 200B of a back-illuminated key architecture according to one or more implementations of the subject technology. The cross-sectional view 200B depicts structural details as seen from the cross section 200 of the back-illuminated key architecture shown in the cut-out view 200A. The structural components depicted in the cross-sectional view 200B include a fingerprint identification key module 202, the light diffusing component 108, adhesives 206 (e.g., an optically clear adhesive), the LED 114, the light seal 112, a packaging module 212 including a flexure (e.g., 120 of FIG. 1B), an insulator (e.g., 122 of FIG. 1B), and screws (e.g., 124 of FIG. 1B), and the enclosure. As seen from the cross-sectional view 200B, the light rays from the LED 114 are guided by the LGP, which may be microperforated in select locations to make the light shine towards the key in a uniform way. The light may be contained in the LGP 116 by the reflector 118 to improve efficiency and uniformity. The light rays may shine through micro-perforations or other openings in the mounting element (e.g., the top case 110). The micro-perforations or other openings may be dimensioned with field of view overlap to prevent bright spots.

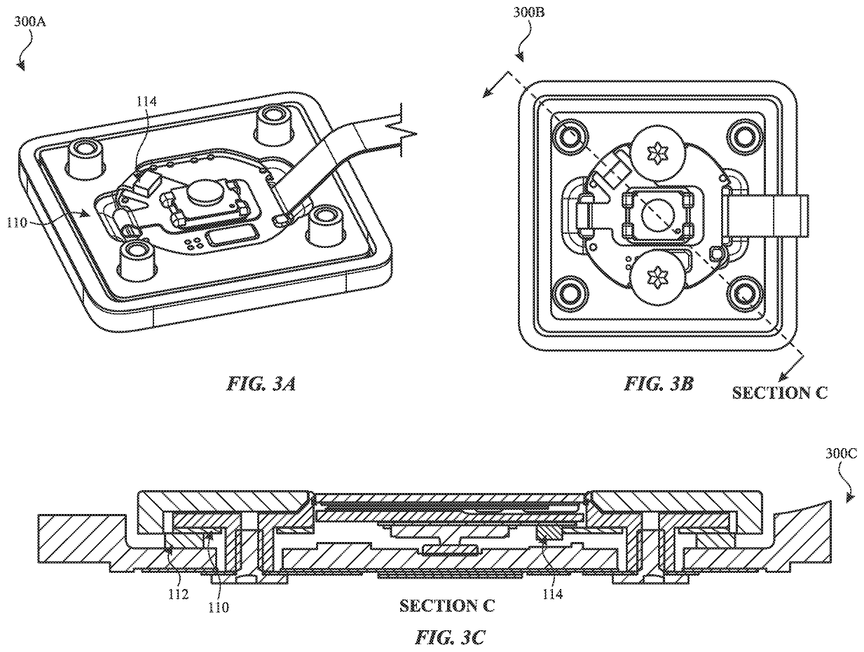

FIGS. 3A, 3B, and 3C are diagrams illustrating a perspective view 300A, a bottom view 300B, and a cross-sectional view 300C of a back-illuminated key architecture according to one or more implementations of the subject technology. The perspective view 300A, the bottom view 300B, and the cross-sectional view 300C depict the back-illuminated key architecture in which the LED 114 is integrated into the module under the key cap and the LGP 116 is added on the underside of the back-illuminated key architecture. This architecture provides an overall simpler design, which allows a direct illumination for the key and is self-contained. When having separate backlight designs for the keyboard and the fingerprint identification key are desired, the LED color can be controlled and/or binned on the fingerprint identification module backlight.

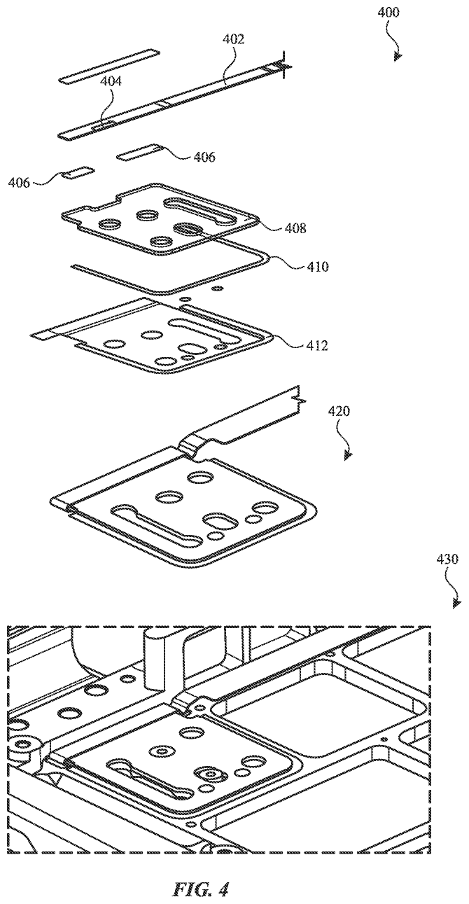

FIG. 4 is a diagram illustrating an exploded view 400 of a back-illuminated key architecture according to one or more implementations of the subject technology. The back-illuminated key architecture shown in the exploded view 400 includes a flex 402 in which LEDs 404 are embedded using an adhesive 406 (e.g., an optically clear adhesive) that is applied to the corners of the LEDs 404, the LGP 408, an adhesive layer 410, and a reflector 412. The adhesive layer 410 bonds the assembly 420 to a key holder assembly 430. In the assembly 420, the LEDs 404 are shown to be integrated onto the LGP 408. The assembly 420 forms a single key integrated into the key holder assembly 430.

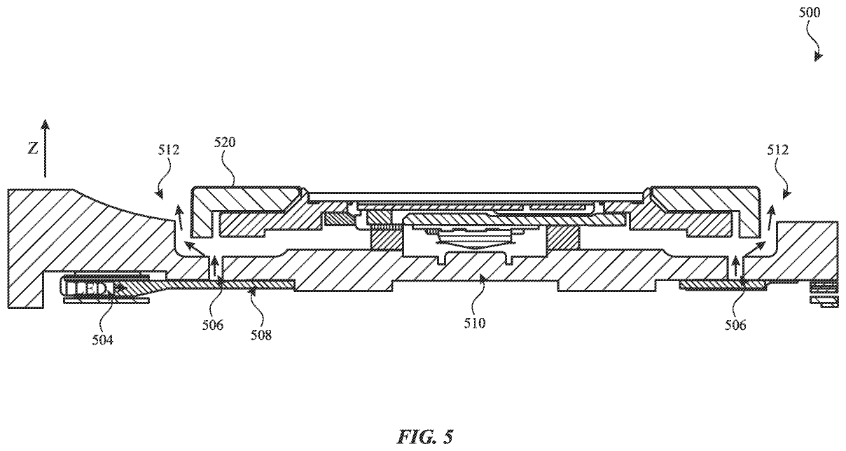

FIG. 5 is a diagram illustrating a cross-sectional view 500 of a back-illuminated key architecture according to one or more implementations of the subject technology. The back-illuminated key architecture shown in the cross-sectional view 500 demonstrates the transmission of light rays 512 from the LED 504 through the LGP 508 to around the edges of the keycap 520. A light path from edges of the LGP 508 through clearance holes 506 within the enclosure structure 510 significantly contributes to the halo appearing around the keycap 520. The LGP 508 may include dot openings to scatter light in the direction of the Z axis. The observed halo appears to be dominated by the collection of light rays 512 on the enclosure sidewall corner (pocket) curvature radius. In the back-illuminated key architecture shown in the cross-sectional view 500, a foam diffuser is omitted in order to improve key tactile feel as well as allow the use of the limited vertical space for packaging the key and the backlight.

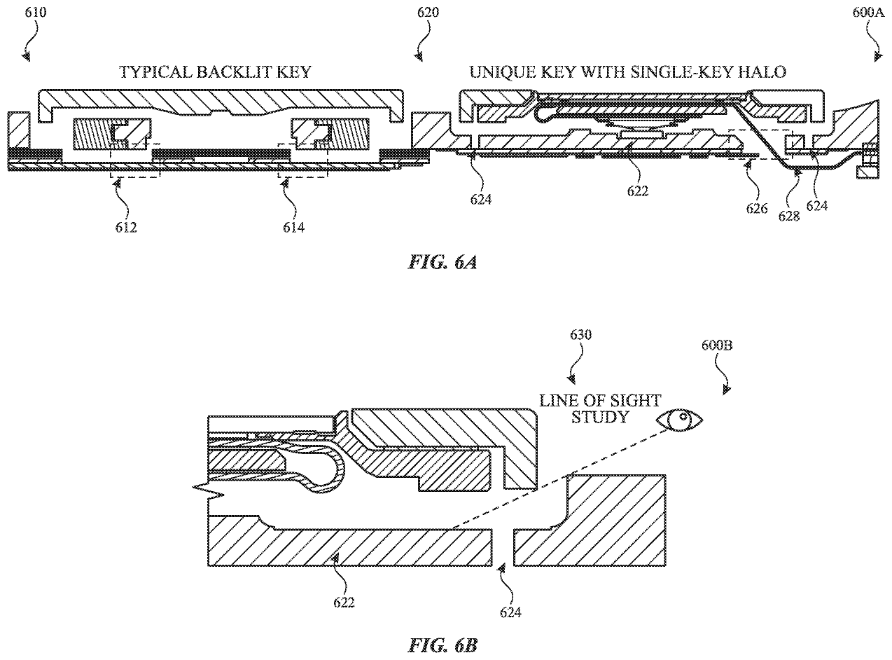

FIGS. 6A and 6B are diagrams illustrating cross-sectional views 600A and 600B of a back-illuminated key architecture according to one or more implementations of the subject technology. In the back-illuminated key architecture shown in the cross-sectional view 600A, a typical backlit key 610 is depicted alongside a unique key 620 (e.g., a fingerprint identification key) having a similar halo as the typical backlit key 610. In the backlit key 610 and the unique key 620, a foam diffuser is not used in order to improve key tactile feel as well as allow the use of the limited vertical space for packaging the key and the backlight. In the backlit key 610, open areas 612 and 614 are provided for light propagation. In the unique key 620, an enclosure structure 622, needed for the specific key function, is provided. The enclosure structure 622 includes perforations 624 and an opening 626 for the flex 628 of the unique key 620. The cross-sectional view 600B depicts a line of sight 630 through the openings around the edge off the unique key 620 to the perforation 624 in the enclosure 622 that allows transmission of light rays to the edges of the unique key 620.

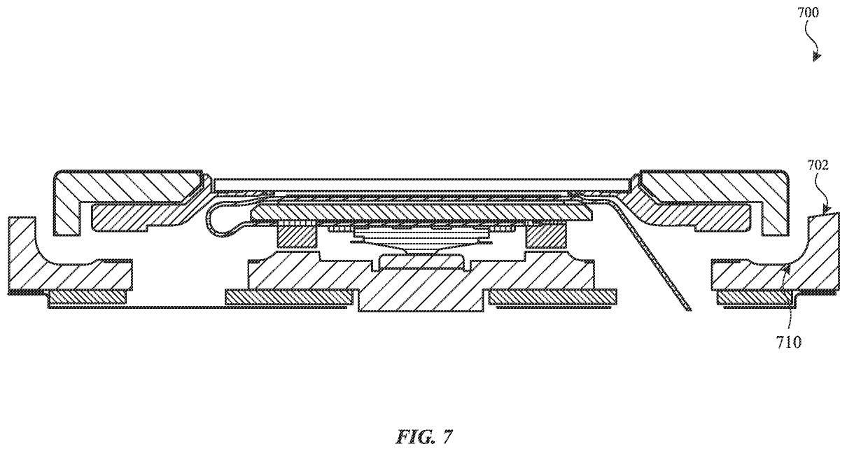

FIG. 7 is a diagram illustrating a cross-sectional view 700 of a back-illuminated key architecture according to one or more implementations of the subject technology. The back-illuminated key architecture shown in the cross-sectional view 700 is similar to the unique key 620 with the single-key halo of FIG. 6A, in which the size of a pocket radius 710 (also referred to as fillet) in the enclosure 702 is increased in order to make the halo around the key appear “softer.” The fillet used in the implementation shown in FIG. 7 is defined using a circular arc, and the radius of the arc defines the size of the fillet. The desired range of radii is typically determined by the process and tool used to fabricate the enclosure. For example, for a computer numerical control (CNC) milling, a deeper pocket would require a larger radius. In some implementations, the radius can be within a range of about 0.3 to 0.6 mm.

As mentioned above, features of the subject technology allows tuning the appearance of the halo around the key.

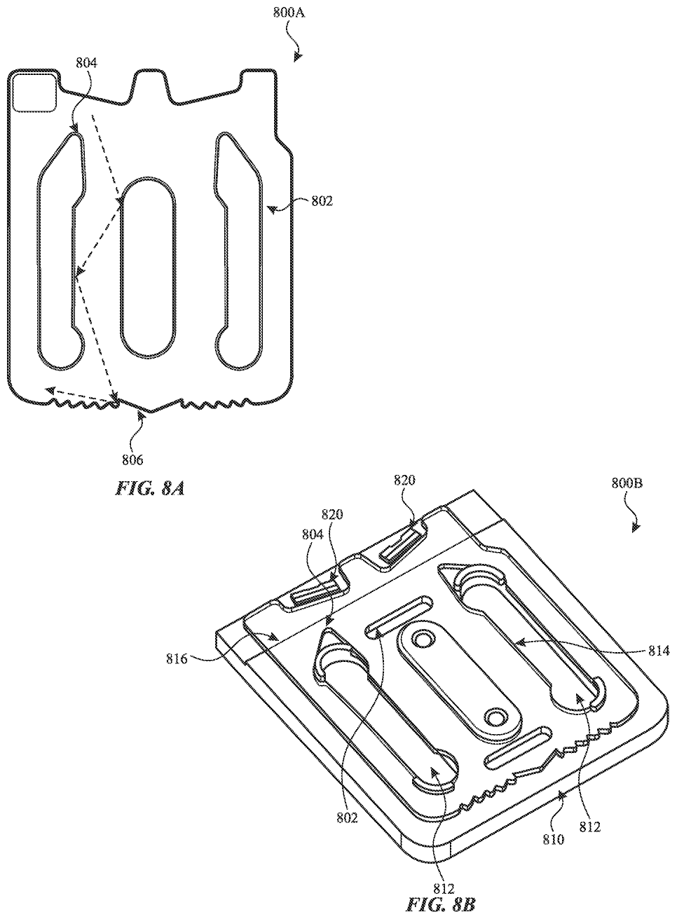

FIGS. 8A and 8B are diagrams illustrating a top view 800A and a perspective view 800B of an LGP according to one or more implementations of the subject technology. The top view 800A shows optical dot openings 802, pointed shape (e.g., triangular) cutouts 804, and a lens array 806. The triangular cutouts 804 are provided at one end of the two slot openings 812 adjacent to the LEDs 820 to pull bright edges away from enclosure slot openings to improve uniformity. The lens array 806 distributes light into left and/or right corners for optical dot openings 802.

The perspective view 800B shows a simplified enclosure 810, an LGP 816, and LEDs 820. The LGP 816 includes the optical dot 802, large slot openings 812 with the triangular cutouts 804, and the edge structure 814. The triangular cutouts 804 move the leading edge of the LED 820 light away from the enclosure cutouts under the large slot openings 812. The edge structure 814 of the LGP 816 is used to transmit light through the enclosure 810.

The disclosed architecture shown in FIGS. 8A and 8B uses the sides of the LGP 816 (e.g., the edge structure 814 of the LGP) instead of just optical dot openings as the light source. A lens array may be formed in the LGP 816 to distribute light more evenly into the corners of the LGP 816. The edges of the LGP 816 in front of the LEDs may be very bright. Triangular cutouts 804 may be added to the LGP to move these edges away from the cutout in the enclosure to help reduce bright spots in the halo around the key.

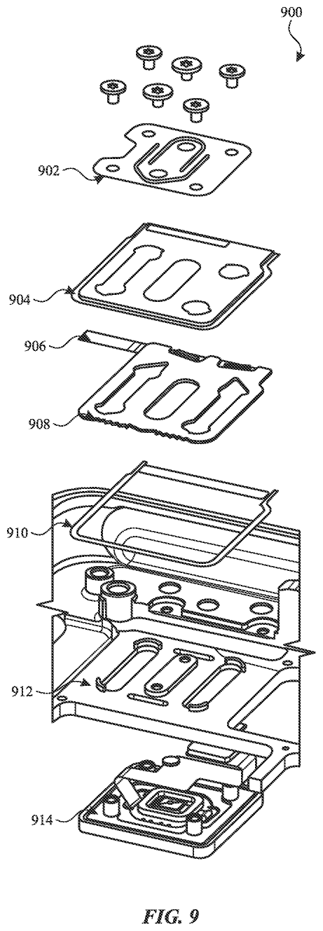

FIG. 9 is a diagram illustrating an exploded view 900 of a back-illuminated key architecture according to one or more implementations of the subject technology. The back-illuminated key architecture, as shown the exploded view 900, includes a flexure 902, a reflector 904, a flex 906 with LEDs, an LGP 908, an adhesive 910, which secures the backlight assembly to an enclosure 912, and a module 914 integrated into a key.

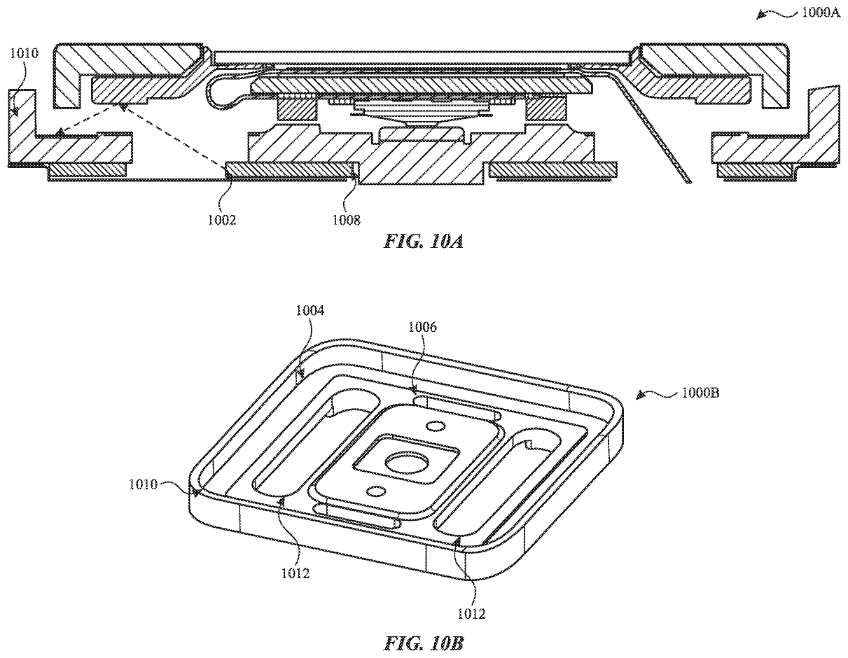

FIGS. 10A and 10B are diagrams illustrating a cross-sectional view 1000A and a perspective view 1000B of a back-illuminated key architecture according to one or more implementations of the subject technology. In the example, back-illuminated key architectures are shown in the cross-sectional view 1000A, and the arrow 1002 shows a light ray passing an edge of the LGP 1008 to a sharp-edge corner of the enclosure 1010.

The perspective view 1000B of the back-illuminated key architecture shows a sharp edge 1004, dot openings 1006 (small slot openings), and large slot openings 1012. The dot openings 1006 are provided for the transmission of light from optical dot (e.g., 802 of FIG. 8) on the LGP 816 of FIG. 8, and the large slot openings 1008 are for light transmission from sides of the LGP. The enclosure 1010 is modified to not include a radius for the light to accumulate and form a sharp halo, instead, the edge walls of the enclosure 1010 form a sharp angle (e.g., nearly 90 degrees) with a floor of the enclosure. In these embodiments, the halo is driven by reflections off the floor of the enclosure 1010. The pulse-width modulation (PWM) input of the LEDs may be increased to compensate for this change in illumination architecture. In some implementations, the sharp edge 1004 may be utilized to tune the look of the halo.

The example back-illuminated key of the subject technology, as described above, may be used by any apparatus including, but not limited to, a desktop, a laptop, a tablet, a phone, or any other electronic or communication device.

As used herein, the phrase “at least one of” preceding a series of items, with the term “and” or “or” to separate any of the items, modifies the list as a whole rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but rather are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, or any other variations thereof and alike are for convenience and do not imply that a disclosure relating to such phrase(s) is essential to the subject technology, or that such disclosure applies to all configurations of the subject technology. A disclosure relating to such phrase(s) may apply to all configurations or to one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the term “comprise”, as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neutral genders (e.g., her and its), and vice versa. Headings and subheadings, if any, are used for convenience only and do not limit the subject disclosure.

1. A keyboard, comprising:
a mechanical structure; and
a key attached to the mechanical structure;
the key comprising:
a light guide panel;
one or more light sources configured to emit light into the light guide panel; and
a reflector attached to the light guide panel configured to reflect the light from the light guide panel through an opening in the mechanical structure to illuminate a periphery of the key.

2. The keyboard of claim 1, wherein the one or more light sources comprises one or more light emitting diodes (LEDs) embedded in a Flex ribbon attached to the reflector.

3. The keyboard of claim 1, wherein the one or more light sources comprises one or more LEDs embedded under a key cap of the key.

4. The keyboard of claim 1, wherein the light guide panel includes two or more optical dot openings configured to allow the light to pass through the mechanical structure.

5. The keyboard of claim 1, wherein the light guide panel includes two or more optical dot openings and at least two slot openings.

6. The keyboard of claim 5, wherein the mechanical structure comprises an enclosure for the key and includes dot openings and slot openings matching the two or more optical dot openings and the at least two slot openings.

7. The keyboard of claim 6, wherein the reflector includes matching dot openings and slot openings similar to the dot openings and the slot openings of the enclosure.

8. The keyboard of claim 6, wherein the at least two slot openings of the light guide panel further include pointed shape cutouts at one end of the at least two slot openings adjacent to the one or more light sources.

9. The keyboard of claim 8, wherein the pointed shape cutouts comprise triangular cutouts configured to move bright edges near the one or more light sources away from the slot openings of the enclosure.

10. The keyboard of claim 8, wherein at least one of the at least two slot openings of the light guide panel further include an edge structure configured to transmit the light through the enclosure.

11. The keyboard of claim 8, wherein the enclosure includes edge walls forming a sharp angle with a floor of the enclosure to allow illumination of the periphery of the key to be driven by reflections from the floor of the enclosure.

12. The keyboard of claim 1, wherein the light guide panel further includes a lens array formed on an edge of the light guide panel opposite to the one or more light sources.

13. The keyboard of claim 1, wherein the light guide panel is coupled to the reflector via an optically clear adhesive.

14. The keyboard of claim 1, wherein the key comprises a fingerprint identification key and further includes a fingerprint indentation module.

15. A keyboard, comprising:
a plurality of keys;
a fingerprint identification key; and
a mechanical structure, including an enclosure for each of the plurality of keys and the fingerprint identification key,
wherein:
each key of the plurality of keys and the fingerprint identification key comprises:
one or more light emitting diodes (LEDs),
a light guide panel configured to uniformly distribute light from the LEDs; and
a reflector attached to the light guide panel and configured to reflect the light from the light guide panel through an opening in the enclosure to uniformly illuminate a periphery of the key and the fingerprint identification key.

16. The keyboard of claim 15, wherein the light guide panel includes two or more optical dot openings and at least two slot openings configured to allow the light to pass through the mechanical structure, and wherein the enclosure comprises includes dot openings and slot openings matching the two or more optical dot openings and the at least two slot openings.

17. The keyboard of claim 16, wherein the at least two slot openings of the light guide panel further include triangular cutouts at one end of the at least two slot openings adjacent to the one or more LEDs, wherein the light guide panel further includes a lens array formed on an edge of the light guide panel opposite to the one or more LEDs, and wherein at least one of the at least two slot openings further include an edge structure configured to transmit the light through the enclosure.

18. The keyboard of claim 16, wherein the reflector is attached to the light guide panel via an optically clear adhesive and includes matching dot openings and slot openings similar to the dot openings and the slot openings of the enclosure.

19. An apparatus, comprising:
a keyboard including a plurality of keys and a fingerprint identification key; and
a mechanical structure configured to provide an enclosure for each of the plurality of keys and the fingerprint identification key,
wherein each key of the plurality of keys and the fingerprint identification key comprises:
a light guide panel configured to uniformly distribute light emitted by one or more light sources, and
a reflector configured to reflect the light from the light guide panel to generate a uniform halo around a periphery of the key and the fingerprint identification key.

20. The apparatus of claim 19, wherein the reflector is configured to reflect the light through one or more openings in the enclosure, wherein the reflector and the light guide panel include dot openings and slot openings matching the openings in the enclosure, wherein at least two slot openings of the light guide panel further include pointed shape cutouts, and wherein the light guide panel further includes a lens array.
